(19) United States
(12) Patent Application Publication
(10) Pub. No.: US 2024/0039095 A1
(43) Pub. Date: Feb. 1, 2024

(54) TERMINAL AND BATTERY PROVIDED WITH SAME

(71) Applicant: Prime Planet Energy & Solutions, Inc., Tokyo (JP)

(72) Inventor: Ichirou MURATA, Setsu-shi (JP)

(21) Appl. No.: 18/359,876

(22) Filed: Jul. 27, 2023

(30) Foreign Application Priority Data
Jul. 29, 2022 (JP) 2022-121414

(51) Int. Cl. H01M 50/176; H01M 50/566; H01M 50/557

(52) U.S. Cl. CPC H01M 50/176; H01M 50/566; H01M 50/557

(57) ABSTRACT

A herein disclosed terminal includes a first conductive member, a second conductive member that is electrically connected to the first conductive member, and a welded joint that is for welding and joining the first conductive member and the second conductive member. Then, the first conductive member and the second conductive member are composed of mutually different metals. The welded joint is disposed to penetrate the first conductive member and then to reach the second conductive member. A surface of the welded joint herein is covered with a tape or a resin member.

### CROSS REFERENCE TO RELATED APPLICATIONS

This application claims the benefit of priority to Japanese Patent Application No. 2022-121414 filed on Jul. 29, 2022. The entire contents of this application are hereby incorporated herein by reference.

### BACKGROUND

The present disclosure relates to a terminal and a battery provided with the same.

Recently, regarding terminals (terminals of an electrode, in other words, positive electrode terminal and negative electrode terminal), it is proposed to provide a terminal configured by joining dissimilar metals, in order to implement a favorable join with an external member, such as a bus bar. Japanese Patent Application Publication No. 2022-49729 discloses a terminal configured with a first conductive member and a second conductive member which are dissimilar metals from each other, and the terminal includes a metal joining part at which the first conductive member and the second conductive member are subjected to metal joining for a purpose of enhancing a conduction reliability.

### SUMMARY

However, as a result obtained by the present inventors having performed an intensive study, it has been found that the technique described above has a room for improvement from a perspective of corrosion resistance and conduction reliability. As described particularly, in a case where different kinds of metals are welded, there may be a matter that a crack occurs at the welded joint because of an embrittlement of the welded part, a difference in expansion coefficients of dissimilar metals, or the like. Then, because of the above described crack, an electrically conductive liquid containing a water, a salt water, an electrolytic solution, or the like, may be infiltrated from a surface of the welded joint, and may enter into a boundary surface between the dissimilar metals. Then, when the dissimilar metals are brought into contact with the electrically conductive liquid, a positive-ionization is accelerated on the metal whose electric potential is lower. In other words, there are some fears of corrosion drastically occurring on the metal whose ionization tendency is larger and occurring on the metal whose electric potential is smaller. Accordingly, regarding the terminal configured by welding and joining the dissimilar metals, preventing the liquid from invading through the surface of the welded joint is a problem to be solved by the disclosure.

A purpose of a technique disclosed herein has been made in view of the above-described circumstances and is to provide a terminal that is configured by welding and joining dissimilar metals and that prevents a liquid from invading through a surface of the welded joint.

The herein disclosed terminal includes a first conductive member, a second conductive member that is electrically connected to the first conductive member, and a welded joint that is for welding and joining the first conductive member and the second conductive member. Then, the first conductive member and the second conductive member are composed of mutually different metals. The welded joint is disposed to penetrate the first conductive member so as to reach the second conductive member. A surface of the welded joint is covered with a tape or a resin member.

In accordance with such a configuration, it is possible to provide a terminal that can suppress a liquid from invading through a surface of the welded joint. As described in details, the terminal includes the welded joint that is disposed to penetrate the first conductive member and to reach the second conductive member. Regarding the terminal, by including the welded joint with the configuration described above, it is possible to enhance a conduction reliability of the terminal. Then, it includes a configuration in which a tape and/or a resin member covers a surface of the welded joint. By doing this, it is possible to prevent the liquid from invading through the surface of the welded joint. Thus, it is possible to suppress a matter that the liquid comes into contact with the first conductive member and the second conductive member so as to cause corrosions of the first conductive member and the second conductive member.

### BRIEF DESCRIPTION OF THE DRAWINGS

FIG. 1 is a perspective view that is for schematically showing a battery in accordance with one embodiment.

FIG. 2 is a longitudinal cross section view that is schematically shown along a II-II line of FIG. 1.

FIG. 3 is a longitudinal cross section view that is for schematically showing a main part of a negative electrode terminal in accordance with Embodiment 1.

FIG. 4 is a plane view that is for schematically showing the main part of the negative electrode terminal in accordance with Embodiment 1.

FIG. 5 is a longitudinal cross section view that is for schematically showing a main part of a negative electrode terminal in accordance with Embodiment 2.

FIG. 6 is a plane view that is for schematically showing the main part of the negative electrode terminal in accordance with Embodiment 2.

FIG. 7 is a perspective view that is for schematically showing a battery pack in accordance with one embodiment.

FIG. 8 is a longitudinal cross section view that is for schematically showing a main part of a negative electrode terminal in accordance with Embodiment 3.

FIG. 9 is a longitudinal cross section view that is for schematically showing a main part of a negative electrode terminal in accordance with Embodiment 4.

FIG. 10 is a plane view that is for schematically showing the main part of the negative electrode terminal in accordance with Embodiment 4.

FIG. 11 is a longitudinal cross section view that is for schematically showing a main part of a negative electrode terminal in accordance with Embodiment 5.

FIG. 12 is a plane view that is for schematically showing the main part of the negative electrode terminal in accordance with Embodiment 5.

FIG. 13 is a longitudinal cross section view that is for schematically showing a main part of a negative electrode terminal in accordance with Embodiment 6.

FIG. 14 is a plane view that is for schematically showing the main part of the negative electrode terminal in accordance with Embodiment 6.

### DETAILED DESCRIPTION

Below, while referring to figures, an embodiment in accordance with a present disclosure will be explained. Incidentally, a matter not described in the present specification but required for performing the present disclosure can be grasped as design matters of those skilled in the art based on the related art in the present field. The present disclosure can be executed based on the contents disclosed in the present specification, and the technical common sense in the present field. Additionally, in the following accompanying figures, the same numerals and signs are given to the members/parts providing the same effect. In addition, a dimensional relation (length, width, thickness, or the like) in each figure does not reflect the actual dimensional relation. Incidentally, a numerical value range expressed as “A to B” in the present specification semantically includes A and B, and semantically covers meanings of “preferably more than A” and “preferably less than B”.

Incidentally, in the present specification, the “battery” is a term widely denoting an electric storage device from which an electric energy can be taken out, and is a concept semantically containing the primary battery and the secondary battery. Additionally, in the present specification, the “secondary battery” is a term widely denoting an electric storage device capable of repeatedly charging and discharging, and is a concept semantically containing so-called storage batteries (chemical batteries), such as a lithium ion secondary battery and a nickel hydrogen battery, and semantically containing capacitors (physical batteries), such as an electric double layer capacitor.

<Battery 100>

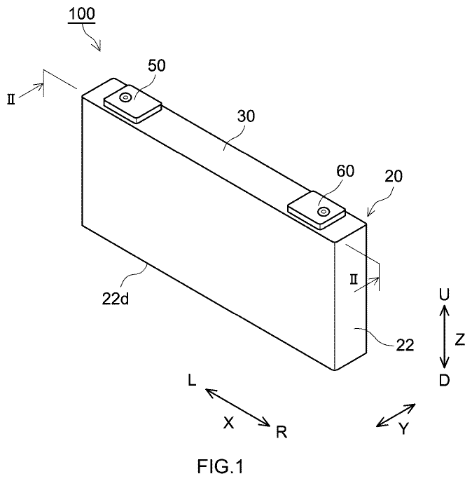

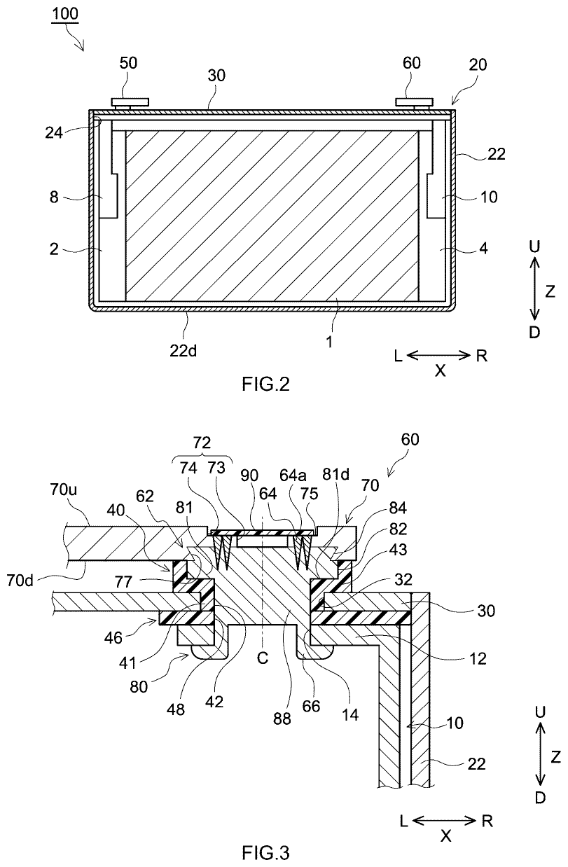

FIG. 1 is a perspective view of a battery 100. FIG. 2 is a longitudinal cross section view that is schematically shown along a II-II line of FIG. 1. Incidentally, in the below described explanation, the reference signs L, R, U, and D in figures respectively represent left, right, up, and down, and the reference signs X, Y, and Z in figures respectively represent a long side direction, a short side direction orthogonal to the long side direction, and a vertical direction of the battery 100. However, these are merely directions for convenience sake of explanation, which are not to restrict the disposed form of the battery 100.

As shown in FIG. 2, the battery 100 includes an electrode body 1, a battery case 20, a positive electrode terminal 50, and a negative electrode terminal 60. The battery 100 is characterized by including a positive electrode terminal 50 and/or negative electrode terminal which are disclosed herein, and the other configurations may be similar to conventional configurations. The battery 100 herein is a lithium ion secondary battery. As the illustration is omitted, the battery 100 herein further includes an electrolyte. The battery 100 can be configured with the electrode body 1 and the electrolyte not shown in figures which are accommodated in the battery case 20.

The electrode body 1 may be similar to a conventional one, and is not particularly restricted. The electrode body 1 includes a positive electrode and a negative electrode (not shown in figures). The electrode body 1 is, for example, a flat wound electrode assembly, in which the positive electrode formed in a strip-like shape and the negative electrode formed in a strip-like shape are laminated through a separator formed in a strip-like shape under an insulated state and then the resultant is wound therein with a winding axis treated as a center. However, the electrode body 1 may be a laminate electrode assembly in which the positive electrode formed in a square shape (typically, rectangular) and the negative electrode formed in a square shape (typically, rectangular) are stacked under an insulated state. The positive electrode includes a positive electrode current collector foil 2 and a positive electrode mixture layer (not shown in figures) that is fixed on the positive electrode current collector foil 2. The positive electrode current collector foil 2, for example, consists of an electrically conductive metal, such as aluminum, aluminum alloy, nickel, and stainless steel. The positive electrode mixture layer includes a positive electrode active material (for example, lithium transition metal composite oxide). The negative electrode includes a negative electrode current collector foil 4 and a negative electrode mixture layer (not shown in figures) that is fixed on the negative electrode current collector foil 4. The negative electrode current collector foil 4 can, for example, consist of an electrically conductive metal, such as copper, copper alloy, nickel, stainless steel, or the like. The negative electrode mixture layer includes a negative electrode active material (for example, carbon material, such as graphite).

As shown in FIG. 2, at a center portion in a long side direction X of the electrode body 1, a laminate portion is formed in which the positive electrode mixture layer and the negative electrode mixture layer are laminated under an insulated state. On the other hand, at a left end part in the long side direction X of the electrode body 1, a portion of the positive electrode current collector foil 2 where the positive electrode mixture layer is not formed (positive electrode current collector foil exposed part) protrudes from the laminate portion. To the positive electrode current collector foil exposed part, a positive electrode current collector 8 is attached. The positive electrode current collector 8 may consist of a metal material being the same as the positive electrode current collector foil 2, which is, for example, an electrically conductive metal, such as aluminum, aluminum alloy, nickel, or stainless steel. In addition, at a right end part in the long side direction X of the electrode body 1, a portion of the negative electrode current collector foil 4 where the negative electrode mixture layer is not formed (negative electrode current collector foil exposed part) protrudes from the laminate portion. To the negative electrode current collector foil exposed part, a negative electrode current collector 10 is attached. A material (metal species) of the negative electrode current collector 10 may be different from the material of the positive electrode current collector 8. The negative electrode current collector 10 may consist of a metal species being the same as the negative electrode current collector foil 4, which is, for example, an electrically conductive metal, such as copper, copper alloy, nickel, and stainless steel. Incidentally, between the positive electrode terminal 50 and the positive electrode current collector 8, or between the negative electrode terminal 60 and the negative electrode current collector 10, a current interrupt device (CID) may be disposed.

The electrolyte may be similar to a conventional one, and is not particularly restricted. The electrolyte is, for example, a nonaqueous liquid electrolyte (nonaqueous electrolytic solution) that contains a nonaqueous solvent and a supporting salt. The nonaqueous solvent includes, for example, carbonates, such as ethylene carbonate, dimethyl carbonate, and ethyl methyl carbonate. The supporting salt is, for example, a fluorine-containing lithium salt, such as LiPF₆. However, the electrolyte may be in a solid state (solid electrolyte), and may be integrated with the electrode body 1.

The battery case 20 is a housing that is configured to accommodate the electrode body 1. The battery case 20 herein is formed in a flat and bottomed cuboid shape (square shape). However, a shape of the battery case 20 is not restricted to the square shape, and may be an arbitrary shape, such as circular column. A material of the battery case 20 may be the same as a material conventionally used, and is not particularly restricted. The battery case 20 is, for example, configured with a lightweight metallic material of good thermal conductivity, such as aluminum, aluminum alloy, and stainless steel. As shown in FIG. 2, the battery case 20 can include a case main body 22 having an opening part 24, and include a sealing plate (lid body) 30 configured to cover the opening part 24. The sealing plate 30 can be provided with a thin-walled safety valve (not shown in figures) being set to release an internal pressure of the battery case 20 when the internal pressure rises to be equal to or more than a predetermined level, and provided with an injection port (not shown in figures) being for injecting the nonaqueous electrolyte. The battery case 20 is integrated by joining (for example, welding and joining) the sealing plate 30 to a peripheral edge of the opening part 24 of the case main body 22. The battery case 20 is airtightly sealed (hermetically sealed).

The case main body 22 includes a bottom surface 22d formed in a flat-plate shape. The sealing plate 30 is opposed to the bottom surface 22d of the case main body 22. The sealing plate 30 is attached to the case main body 22 to cover the opening part 24 of the case main body 22. The sealing plate 30 herein is formed in an approximately rectangular shape. Incidentally, “approximately rectangular shape” in the present specification is a term that semantically covers not only a complete rectangular shape (oblong shape), but also, for example, a shape whose corner part connecting a long side and short side of the rectangular shape is like R, a shape whose corner part includes a notch, or the like.

As shown in FIG. 1, the positive electrode terminal 50 and the negative electrode terminal 60 protrude toward the outer side of the battery case 20. The positive electrode terminal 50 and the negative electrode terminal 60 both protrude from the same surface (specifically, sealing plate 30) of the battery case 20, herein. However, the positive electrode terminal 50 and the negative electrode terminal 60 may protrude from different surfaces of the battery case 20, from each other. The positive electrode terminal 50 and the negative electrode terminal 60 can be arranged at opposite end portions in the long side direction X of the sealing plate 30. The positive electrode terminal 50 and/or the negative electrode terminal 60 are examples of the herein disclosed terminal.

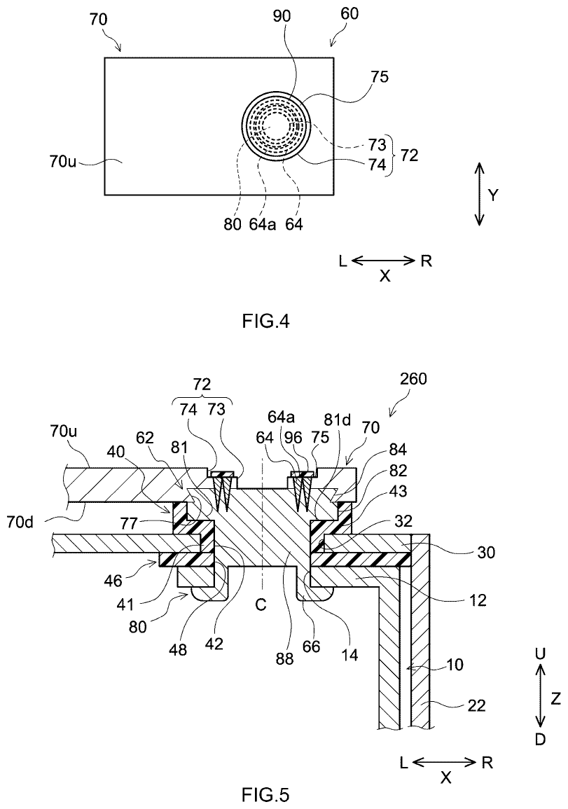

FIG. 3 is a longitudinal cross section view that is for schematically showing a main part of the negative electrode terminal 60 in accordance with Embodiment 1. In addition, FIG. 4 is a plane view that is for schematically showing the main part of the negative electrode terminal 60 in accordance with Embodiment 1. Incidentally, a terminal structure at a side of the negative electrode terminal 60 is explained as an example below in details, but the terminal structure at the side of the positive electrode terminal 50 may be also similar. In that case, regarding below-described contents, it is possible to suitably replace a portion of “negative electrode” with “positive electrode”.

As shown in FIG. 3, a terminal attaching hole 32 penetrating in a vertical direction Z is formed on the sealing plate 30. In a plane view, the terminal attaching hole 32 is, for example, formed in a ring shape (for example, annular shape). The terminal attaching hole 32 has an inner diameter whose size allows a later-described connecting part 88 before a caulking process of the negative electrode terminal 60 to be inserted. The terminal attaching hole 32 is formed to be smaller than a later-described flange part 81 of the negative electrode terminal 60.

The negative electrode current collector 10 is attached to the negative electrode current collector foil exposed part of the negative electrode current collector foil 4, so as to configure a conduction path that electrically connects the negative electrode and the negative electrode terminal 60. The negative electrode current collector 10 includes a flat plate-shaped portion 12 that extends horizontally along a surface at an inner side of the sealing plate 30. A penetration hole 14 is formed in the flat plate-shaped portion 12, at a position corresponding to the terminal attaching hole 32. The penetration hole 14 has an inner diameter whose size allows the later-described connecting part 88 before the caulking process of the negative electrode terminal 60 to be inserted. The negative electrode current collector 10 is fixed by the caulking process to the sealing plate 30 through an insulator 46 in an insulated state.

A gasket 40 is an insulating member arranged between an upper surface (outward surface) of the sealing plate 30 and the negative electrode terminal 60. The gasket 40 herein has a function of insulating the sealing plate 30 and the negative electrode terminal 60, and of closing the terminal attaching hole 32. The gasket 40 has an electric insulating property, and is configured with an elastically deformable resin material, for example, a fluorinated resin, such as a perfluoroalkoxy fluorine resin (PFA), a polyphenylene sulfide resin (PPS), an aliphatic polyamide, or the like.

The gasket 40 includes a cylindrical portion 41 and a base 43. The cylindrical portion 41 is a portion configured to inhibit the sealing plate 30 and the connecting part 88 of the negative electrode terminal 60 from directly coming into contact with each other. The cylindrical portion 41 is formed in a hollow cylindrical shape. The cylindrical portion 41 includes a penetration hole 42 that penetrates in the vertical direction Z. The penetration hole 42 is formed to be capable of making the connecting part 88 of the negative electrode terminal 60 before the caulking process be inserted. The cylindrical portion 41 is inserted into the terminal attaching hole 32 of the sealing plate 30. The base 43 is a portion configured to inhibit the sealing plate 30 and the later described flange part 81 of the negative electrode terminal 60 from directly coming into contact with each other. The base 43 is coupled to a top end of the cylindrical portion 41. The base 43 extends in a horizontal direction from the top end of the cylindrical portion 41. The base 43 is formed, for example, in an annular shape to surround the terminal attaching hole 32 of the sealing plate 30. The base 43 extends along the upper surface of the sealing plate 30. The base 43 is sandwiched between a lower surface 81d of the flange part 81 of the negative electrode terminal 60 and the upper surface of the sealing plate 30, so as to be compressed in the vertical direction Z by the caulking process.

The insulator 46 is an insulating member that is arranged between a lower surface (inward surface) of the sealing plate 30 and the negative electrode current collector 10. The insulator 46 has a function of insulating the sealing plate 30 and the negative electrode current collector 10. The insulator 46 includes a flat plate-shaped portion that extends horizontally along an inner surface of the sealing plate 30. A penetration hole 48 is formed in the flat plate-shaped portion, at a position corresponding to the terminal attaching hole 32. The penetration hole 48 has an inner diameter whose size allows the connecting part 88 of the negative electrode terminal 60 to be inserted. The insulator 46 has a resistant property with respect to the used electrolyte and an electric insulating property, and is configured with an elastically deformable resin material, for example, a fluorinated resin, such as a perfluoroalkoxy fluorine resin (PFA), a polyphenylene sulfide resin (PPS), or the like. The flat plate-shaped portion of the insulator 46 is sandwiched between the lower surface of the sealing plate 30 and the upper surface of the negative electrode current collector 10, so as to be compressed in the vertical direction Z by the caulking process.

<Negative Electrode Terminal 60>

The negative electrode terminal 60 is inserted into the terminal attaching hole 32 and then extends from the interior of the battery case 20 towards the exterior. As described later, the negative electrode terminal 60 is configured with a first conductive member 70 and a second conductive member 80 which are conductive members consist of two types of different metals and which are integrated by a welded joint 64. As shown in FIG. 3, the negative electrode terminal 60 is caulked at a peripheral edge portion surrounding the terminal attaching hole 32 of the sealing plate 30 by the caulking process, while being in a state insulated from the sealing plate 30. At a lower end part of the negative electrode terminal 60, a rivet part 66 is formed. The negative electrode terminal 60 is fixed to the sealing plate 30 by the caulking process and is electrically connected to the negative electrode current collector 10.

As shown in FIG. 3, the negative electrode terminal 60 in accordance with the present disclosure includes the first conductive member 70, the second conductive member 80, and the welded joint 64, and further includes a tape 90 and/or a resin member 96 (see FIG. 5).

Additionally, as shown in FIG. 3, in some preferred embodiments, the negative electrode terminal 60 includes a fastening part 62. The first conductive member 70 and the second conductive member 80 are integrated through the fastening part 62 and the welded joint 64, and are electrically connected to each other.

The first conductive member 70 is a member that is disposed outside the battery case 20. The first conductive member 70 herein is made of a metal. The first conductive member 70 is, for example, an electrically conductive metal, such as aluminum, aluminum alloy, nickel, stainless steel, copper, or copper alloy, and it is preferable that the first conductive member is aluminum or aluminum alloy. As shown in FIG. 3 and FIG. 4, the first conductive member 70 herein is flat plate-shaped. Although not particularly restricted, the first conductive member 70 herein is formed in an approximately rectangular shape that extends in the long side direction X. The first conductive member 70 includes a lower surface 70d and an upper surface 70u. The lower surface 70d is a surface at a side opposed to the battery case 20 (specifically, the sealing plate 30). The upper surface 70u is a surface at a side far from the battery case 20. In the present disclosure, the lower surface is an example of “one surface” and the upper surface is an example of “the other surface”.

The first conductive member 70 includes a recess 77 that is recessed from the lower surface 70d of the first conductive member 70. The recess 77 is provided at an outer circumferential side than the welded joint 64. As the illustration is omitted, the recess 77 is formed to be a ring shape (for example, annular shape) in a plane view. The recess 77 herein is formed in a taper shape whose diameter is reduced more toward the lower surface 70d of the first conductive member 70 (in other words, reduced more at a position closer to the second conductive member 80). Into the recess 77, a later-described constricted portion 84 of the second conductive member 80 is inserted.

The first conductive member 70 includes the penetration hole 72 that penetrates in the vertical direction Z. The penetration hole 72 is formed to be a ring shape (for example, annular shape) in a plane view. As shown in FIG. 3, the penetration hole 72 herein includes a first area (small-diameter part) 73 and a second area (large-diameter part) 74. The first area 73 is an area whose diameter is smaller than the second area 74. In addition, the first area 73 is arranged at a position closer to the second conductive member 80, than the second area 74. Between the first area 73 and the second area 74, a flat area 75 is formed that extends from a top end of the first area 73 in the horizontal direction. Then, a second conductive member 80 (specifically, later described flange part 81) is arranged so as to cover the penetration hole 72. By the configuration described above, it is possible, in a case where the first conductive member 70 and the second conductive member 80 are welded and fixed, to obtain an effect of a gas-passing flow channel at the time of welding. In addition, by the caulking process (riveting), it is possible to obtain an effect as an air through hole in a case where the negative electrode terminal 60 is fixed to the sealing plate 30. Then, on the upper surface 70u of the first conductive member 70, the second conductive member 80 (specifically, later described flange part 81) is exposed from the penetration hole 72.

The second conductive member 80 is a member that extends from the interior of the battery case 20 toward the exterior. The second conductive member 80 herein is made of a metal. The second conductive member 80 is, for example, an electrically conductive metal, such as copper, copper alloy, nickel, stainless steel, aluminum, and aluminum alloy, and it is preferable that the second conductive member is copper or copper alloy. The second conductive member 80 may include, on a part or the whole of the surface, a metal-coated portion on which a metal, whose kind is different from the first conductive member 70, is covering. By doing this, it is possible to enhance a welding quality with the first conductive member. Incidentally, it is preferable that the metal-coated portion of the second conductive member 80 is disposed at a surface on which the first conductive member 70 and the second conductive member 80 abut on each other. As shown in FIG. 3, the second conductive member 80 has an axis center C. Here, the second conductive member 80 includes the flange part 81 at one end part and the connecting part (shaft column part) 88 at the other end part, the flange part is electrically connected to the first conductive member 70, and the connecting part (shaft column part) 88 is coupled to a lower end part of the flange part 81.

On the herein disclosed terminal, the first conductive member 70 and the second conductive member 80 can be configured with different metals from each other. In some preferred embodiments, the first conductive member 70 is configured with aluminum or aluminum alloy, and the second conductive member 80 is configured with copper or copper alloy. On the other hand, another aspect can be allowed in which the first conductive member 70 is configured with copper or copper alloy and the second conductive member 80 is configured with aluminum or aluminum alloy. The terminal consisting of the configuration described above can be used, for example, as for a rapid charge battery, or the like.

The flange part 81 has an outer shape which is larger than the connecting part 88. As shown in FIG. 3, the flange part 81 has the outer shape which is larger than the terminal attaching hole 32 of the sealing plate 30. The flange part 81 is a portion that protrudes from the terminal attaching hole 32 of the sealing plate 30 to the outside of the battery case 20. As the illustration is omitted, the outer shape of the flange part 81 herein is formed in an approximately circular column shape, and an axial center of the flange part 81 and the axis center C of the second conductive member 80 are identical to each other. As shown in FIG. 3, the flange part 81 includes the lower surface 81d, a side surface (outer circumferential surface) 82 that extends upward from the lower surface 81d, and the constricted portion 84 that is a part of the side surface 82 being narrowed.

The constricted portion 84 is continuously or intermittently provided at a part of the side surface 82 of the flange part 81. As the illustration is omitted, the constricted portion 84 is formed to be a ring shape (for example, annular shape) in a plane view. By making the constricted portion 84 be formed in a ring shape, it is possible to form the fastening part 62 having a high strength. The constricted portion 84 is formed in an axis symmetrical manner with respect to the axis center C of the flange part 81. The constricted portion 84 is formed in a reverse taper shape whose diameter is enlarged toward the upper surface 70u (in other words, enlarged more at a position far from the connecting part 88). The constricted portion 84 is inserted into the recess 77 of the first conductive member 70. The constricted portion 84 herein is fit into the recess 77 of the first conductive member 70 and engaged with the recess 77. The constricted portion 84 is an example of “portion accommodated in the recess 77”, in the present disclosure.

As shown in FIG. 3, the connecting part 88 extends downward from the lower end part of the flange part 81. The connecting part 88 herein is formed in a cylindrical shape. An axis center of the connecting part 88 is identical to the axis center C of the flange part 81. Before the caulking process, the lower end part of the connecting part 88, in other words, an end part at a side opposite to the side at which the flange part 81 is positioned, is formed in a hollow shape. As shown in FIG. 3, the connecting part 88 is a portion that is inserted into the terminal attaching hole 32 of the sealing plate 30 when the negative electrode terminal 60 is attached to the sealing plate 30. The lower end part of the connecting part 88 is a portion that is expanded by the caulking process so as to configure the rivet part 66 when the negative electrode terminal 60 is attached to the sealing plate 30. The connecting part 88 is electrically connected to the negative electrode current collector 10 inside the battery case 20 by the caulking process.

The fastening part 62 is a coupling part that is configured to mechanically fix the first conductive member 70 and the flange part 81 of the second conductive member 80. It is preferable that the fastening part 62 is provided at an outer circumferential side of the flange part 81 than the welded joint 64 in a plane view. The fastening part 62 is formed to be a ring shape (for example, annular shape) in a plane view. By doing this, it is possible to increase the strength of the fastening part 62 and further enhance a conduction reliability of the negative electrode terminal 60. The fastening part 62 is configured by making an inner wall of the recess 77 of the first conductive member 70 be fixed (for example, subjected to press fixing) at the constricted portion 84 of the second conductive member 80. By doing this, it is possible to suitably fix the first conductive member 70 and the second conductive member so as to enhance the strength of the fastening part 62. A forming method of the fastening part 62 is not particularly restricted if mechanical joining with a mechanical energy is used, and for example, may be press fitting, shrink fitting, caulking, riveting, folding, bolt joining, or the like.

The welded joint 64 is a metallurgical joining part with the first conductive member and the flange part 81 of the second conductive member 80. Incidentally, in the present specification, the wording “welded joint” means a portion at which a metal configuring the conductive member melted at the welding time and then was coagulated. The welded joint 64 herein is provided on the upper surface 70u of the first conductive member 70. As shown in FIG. 3, it is preferable that the welded joint 64 is formed to penetrate the first conductive member 70 from the upper surface 70u of the first conductive member 70 in the vertical direction Z so as to reach the second conductive member 80. By doing this, it is possible to enhance the strength of the welded joint 64 so as to further enhance the conduction reliability of the negative electrode terminal 60. It is preferable that the welded joint 64 is provided at a position spaced away from the fastening part 62. In addition, it is preferable that the welded joint 64 is provided at a inner periphery side (center side) of the flange part 81 in a plane view, than the fastening part 62. The welded joint 64 is formed with light energy, electronic energy, heat energy, or the like, and thus is a joining part whose strength is relatively lower (fragile), than the fastening part 62. By disposing the welded joint 64 as described above at the inner periphery side of the fastening part 62, it is possible to keep the welded joint 64 in a stable manner, so as to increase the conduction reliability of the negative electrode terminal 60 for a long period. The welded joint 64 herein is provided on the flat area 75. By doing this, the energy required at the joining time is reduced, and thus it is possible to enhance the welding property. The welded joint 64 is formed continuously or intermittently. The welded joint 64 is formed in an axis symmetrical manner with respect to the axis center C of the flange part 81. By doing this, it is possible to increase the strength of the welded joint 64 and furthermore enhance the conduction reliability of the negative electrode terminal 60. The welded joint 64 is formed, in a plane view, to have, for example, a ring shape (for example, annular shape), a circular arc shape, preferably a two- or more-layers circle (for example, multiple circle, such as double circle and triple circle), or a scroll shape. In other words, the welded joint 64 is formed with small welded joints being divided. As shown in FIG. 3 and FIG. 4, the welded joint 64 herein is formed in a double circle shape. By doing this, the welded joint 64 is formed with the small welded joints being divided, and thus it is possible to suppress the crack generation. Therefore, it is possible to increase the strength of the welded joint 64 and further enhance the conduction reliability of the negative electrode terminal 60.

Regarding the forming method of the welded joint 64, it is formed, for example, by welding, such as laser welding, electron beam welding, resistance welding, and TIG (Tungsten Inert Gas) welding. By doing this, it is possible to form the high strength welded joint 64 in a stable manner.

By making the negative electrode terminal 60 include the fastening part 62 and the welded joint 64 as described above, it is possible to keep the conductive connection with the first conductive member 70 and the second conductive member 80 being in a stable manner, so as to enhance the conduction reliability of the negative electrode terminal 60. Although, the fastening part 62 is not essential, and may be omitted in another embodiment.

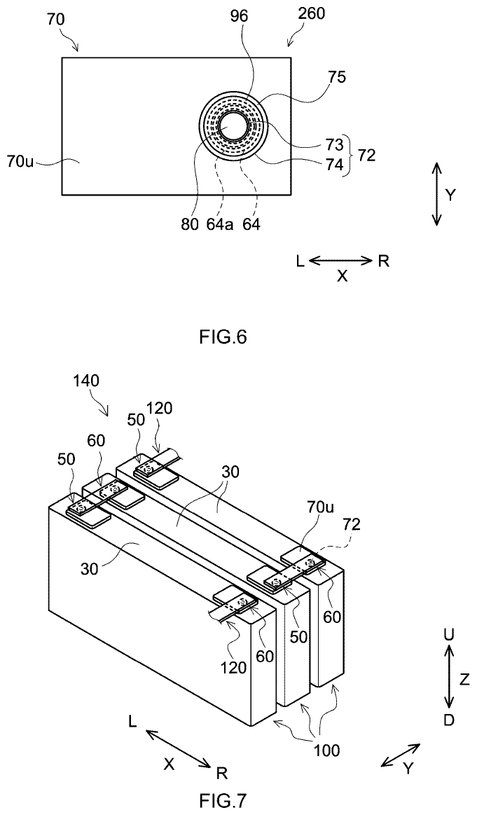

As described above, the welded joint 64 is formed by the first conductive member 70 and the second conductive member 80, which are the different kinds of metals, having melted at the welding time and then having been coagulated. Anyway, in the case where the different kinds of metals are welded, there is a possibility that a crack occurs on the welded joint 64 because of an embrittlement of the alloy part, a difference in expansion coefficients of the dissimilar metals, a local ununiform concentration of a solute element, or the like. When the crack occurs as described above, there is room of allowing the water, or the like, to invade from a surface 64a of the welded joint 64 (specifically, a surface formed on the upper surface 70u of the first conductive member 70 among the welded joint 64). Then, the present disclosure is to cover the above described surface 64a of the welded joint 64 with the tape 90 and/or the resin member 96 (see FIG. 5 and FIG. 6). By doing this, it is possible to prevent the water, or the like, from infiltrating through the surface 64a of the welded joint 64. In other words, it prevents the matter that the water, or the like, invades from the surface 64a of the welded joint 64 and then comes into contact with the first conductive member 70 and the second conductive member 80 which are configured with different kinds of metals. Therefore, it is possible to suppress corrosions of the first conductive member 70 and the second conductive member 80.

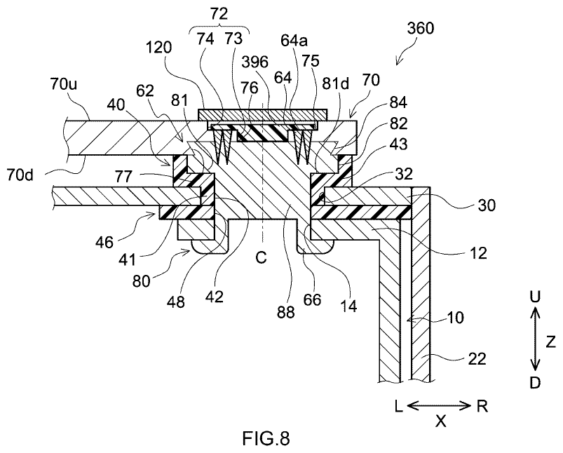

As shown in FIG. 3 and FIG. 4, here, the tape 90 is arranged inside the second area 74 among the upper surface 70u of the first conductive member 70, and is pasted on the flat area 75 (in other words, the tape 490 and the flat area 75 are abutted). By doing this, it is possible to implement a structure in which the tape 90 covers the surface 64a of the welded joint 64. Therefore, it is possible to suitably inhibit the water, or the like, from infiltrating through the surface 64a of the welded joint 64. In addition, although more details are described later, by the configuration described above, for example, in a case where plural batteries 100 are mutually and electrically connected so as to manufacture a battery pack 140 (see FIG. 7), when a bus bar 120 (see FIGS. 7 and 8) is arranged on the upper surface 70u of the first conductive member 70, the tape 90 does not interfere with arrangement. Therefore, it is possible to stably connect the first conductive member 70 and the bus bar 120.

It is preferable that the tape 90 and/or the resin member 96 (see FIG. 5 and FIG. 6) are arranged to come into contact with the surface 64a of the welded joint 64. As shown in FIG. 3 and FIG. 4, the tape 90 herein is arranged to come into contact with the surface 64a of the welded joint 64. By doing this, it is possible to suitably prevent the water, or the like from infiltrating through the surface 64a of the welded joint 64. However, it is not always required to make the tape 90 and/or the resin member 96 come into contact with the surface 64a of the welded joint 64. It is enough for the surface 64a of the welded joint 64 to be covered with the tape 90 and/or the resin member 96.

Regarding the kind of the tape 90, for example, it is possible to use one whose base material coated with a glue agent, a heat welding tape, or the like. As one example of the base material, it is possible to use a polyimide resin (for example, Kapton (registered trademark), or the like), a fluorine type resin (for example, Teflon (registered trademark), Nitflon (registered trademark), or the like), a polyester, or the like. In addition, as the glue agent, it is possible to use, for example, a silicon adhesive agent, an acrylic adhesive agent, or the like, and the silicon adhesive agent can be suitably used from a perspective of heat resistance, durability, electric insulating property, or the like. As the heat welding tape, it is possible to suitably use a polyester resin, and a fluorine type resin.

Here, while referring to a negative electrode terminal 260 in accordance with Embodiment 2, a terminal including the resin member 96 in the present disclosure will be described. FIG. 5 is a longitudinal cross section view that is for schematically showing a main part of the negative electrode terminal 260 in accordance with Embodiment 2. In addition, FIG. 6 is a plane view that is for schematically showing the main part of the negative electrode terminal 260 in accordance with Embodiment 2. The negative electrode terminal 260 may be the same as the above described negative electrode terminal 60, other than a configuration including the resin member 96 instead of the tape 90.

As shown in FIG. 5 and FIG. 6, the resin member 96 herein is arranged at the flat area 75. The resin member 96 herein is formed in a toroidal shape. By doing this, the resin member 96 can have a structure for covering the surface 64a of the welded joint 64. Therefore, it is possible to suitably inhibit the water, or the like, from infiltrating through the surface 64a of the welded joint 64. Incidentally, it is enough for the resin member 96 that the resin member is arranged to cover the surface 64a of the welded joint 64, and it is not required that the resin member is arranged to completely fill the penetration hole 72 (in other words, all of the first area 73 and second area 74).

A kind of the resin member 96 is not restricted unless specifically mentioned, but from a perspective of the heat resistance and the electric insulating property, it is possible to use, for example, an epoxy resin, and then an ultraviolet curing epoxy resin and a 2 liquid mixing epoxy resin are used preferably.

As described above, the negative electrode terminal 60 includes the tape 90 and/or the resin member 96 (see FIG. 5 and FIG. 6). By doing this, it is possible to prevent the infiltration of the water, or the like, from the surface 64a of the welded joint 64 when the crack occurs on the welded joint 64. In other words, it is possible to prevent the matter that the water, or the like, invades from the surface 64a of the welded joint 64 and then comes into contact with the first conductive member 70 and the second conductive member 80 which are composed of mutually different metals. Therefore, it is possible to suppress the corrosions of the first conductive member 70 and the second conductive member 80.

<Method for Producing the Production Method Negative Electrode Terminal 60>

Although not particularly restricted, the negative electrode terminal 60 can be produced, for example, by preparing the first conductive member 70 and the second conductive member 80 as described above, and by performing a production method that includes a conductive member connecting step and a welded joint covering step in this order, typically. However, the herein disclosed production method may further include another step at an arbitrary stage. In addition, when the battery 100 is produced, the welded joint covering step may be performed at an arbitrary timing.

At the conductive member connecting step, the first conductive member 70 and the second conductive member 80 are electrically connected. The conductive member connecting step includes at least the welding and joining step as the sub-step. In some preferred embodiments, the conductive member connecting step can further include a fastening step as the sub-step. An order of the fastening step and the welding and joining step may be reverse, or they may be performed at almost the same time.

At the welding and joining step, the flat area 75 of the first conductive member 70 and the flange part 81 of the second conductive member 80 are subjected to welding, so as to form the welded joint 64. By performing the welding and joining step after the fastening step, it is possible to precisely form the welded joint 64 whose shape has become stable. The welded joint 64 can be formed, for example, by welding a portion, in which the flat area 75 of the first conductive member 70 and the flange part 81 of the second conductive member 80 are laminated, so as to make the portion penetrate the flat area 75. A gas and heat generated by the welding operation are emitted and diffused from the penetration hole 72. As described above, by including the penetration hole 72, it is possible to suppress the gas and heat from staying at an area between the flat area 75 and the flange part 81. By performing the welding operation, it is possible to form the high strength welded joint 64 in a stable manner.

At the fastening step, the first conductive member 70 and the flange part 81 of the second conductive member 80 are mechanically fixed so as to form the fastening part 62. The fastening part 62 is formed by, for example, inserting the constricted portion 84 of the second conductive member 80 into the recess 77 of the first conductive member 70, and by deforming the recess 77 of the first conductive member 70 along the outer shape of the constricted portion 84 of the second conductive member 80 so as to fix the inner wall of the recess 77 with the second conductive member 80. This improves the strength of the fastening part 62. In some preferred embodiments, the fastening part 62 is formed by fitting the recess 77 of the first conductive member 70 and the constricted portion 84 of the second conductive member 80. For example, forming can be implemented by performing a flat press fitting operation on the constricted portion 84 of the second conductive member 80 at the recess 77 of the first conductive member 70. By doing this, it is possible to enhance an operation property of the fastening step.

In some preferred embodiments, the welded joint 64 is formed at an inner periphery side, than the fastening part 62. By doing this, a shift of the joined point can be inhibited, and thus it is possible to enhance the operation property of the welding and joining step. Additionally, in a case where welding is performed to form the welded joint 64, it is possible to inhibit the welded portion from wobbling so as to enhance the welding property. Furthermore, in a case where the flat area 75 is welded, it is possible to reduce the required energy so as to enhance the welding property.

At the welded joint covering step, the tape 90 and/or the resin member 96 are used to cover the surface 64a of the welded joint 64. The welded joint covering step includes at least 1 sub-step selected from the tape pasting step and the resin member arranging step.

At the tape pasting step, the tape 90 is pasted on the negative electrode terminal 60 to cover the surface 64a of the welded joint 64. In some preferred embodiments, the tape 90 is pasted on the first conductive member 70 (specifically, upper surface 70u of the first conductive member 70). In other words, it is preferable that the pasting operation is performed to abut at least a part of the tape 90 and the first conductive member 70. By doing this, the surface 64a of the welded joint 64 is covered with the tape 90. Therefore, it is possible, when the crack occurs on the welded joint 64, to suppress the matter that the water, or the like, infiltrates from the surface 64a of the welded joint 64 so as to cause the corrosions of the first conductive member 70 and the second conductive member 80.

Regarding the pasting method of the tape 90, in a case where a tape whose base material coating with a glue agent is used, for example, the pasting operation is performed to make at least a part of the surface of the tape coated with the glue agent and the upper surface of the first conductive member 70 be opposed to each other. Additionally, in a case where a heat welding tape is used as the tape 90, for example, the tape 90 is arranged on the upper surface 70u of the first conductive member 70 and then the tape 90 is heated. By doing this, the tape 90 melts due to the heat so as to be welded onto the upper surface 70u of the first conductive member 70, and thus the tape 90 is fixed on the first conductive member A welding method of the tape 90 is not particularly restricted, and can be appropriately selected from well known methods based on a material of the tape 90, or the like.

At the resin member arranging step, the resin member 96 is arranged on the negative electrode terminal 60 to cover the surface 64a of the welded joint 64. In some preferred embodiments, the resin member 96 is arranged at the inside of the penetration hole 72. By doing this, the surface 64a of the welded joint 64 is covered with the resin member 96. Therefore, it is possible, when the crack occurs on the welded joint 64, to suppress the matter that the water, or the like, infiltrates from the surface 64a of the welded joint 64 so as to cause the corrosions of the first conductive member 70 and the second conductive member 80. Here, the resin member 96 used at the resin member arranging step is in a liquid state or in a semi-solid state.

In some embodiments, the resin member arranging step could further include a resin member curing step. The curing method for the resin member 96 is not particularly restricted, but a method for curing by mixing a curing agent with a resin main agent is preferably used in a case where a 2 liquid mixing resin is used, and a method for curing by irradiating the resin member 96 with ultraviolet so as to induce a photopolymerization reaction is preferably used in a case where an ultraviolet curing resin is used. However, it is possible to omit the resin member curing step. In other words, it is not necessary to cure the resin member 96.

<Method for Producing the Battery 100>

The battery 100 is characterized by including the positive electrode terminal 50 and/or the negative electrode terminal 60 that are producing by a production method as described above. The production process, other than the above described feature, may be similar to conventional one. The battery 100 can be produced, for example, by preparing the electrode body 1, the electrolyte, the case main body 22, the sealing plate 30, the positive electrode terminal 50, and the negative electrode terminal 60 as described above, and then by performing a production method that includes an attaching step and a joining step.

At the attaching step, the positive electrode terminal 50, the positive electrode current collector 8, the negative electrode terminal 60, and the negative electrode current collector 10 are attached to the sealing plate 30. The negative electrode terminal 60 and the negative electrode current collector 10 are, for example, as shown in FIG. 3, fixed to the sealing plate by the caulking process (riveting). The caulking process is performed, while the gasket is sandwiched between the negative electrode terminal 60 and the sealing plate 30 and further the insulator 46 is sandwiched between the sealing plate 30 and the negative electrode current collector 10. For more details, the connecting part 88 before the caulking process of the negative electrode terminal 60 is configured to penetrate the cylindrical portion 41 of the gasket 40, the terminal attaching hole 32 of the sealing plate 30, the penetration hole 48 of the insulator 46, and the penetration hole 14 of the negative electrode current collector 10 from an upward position of the sealing plate 30 in this order, and is configured to protrude to a downward position of the sealing plate 30. Then, to add a compression force in the vertical direction Z, the connecting part 88 protruding to a downward position of the sealing plate 30 is caulked. By doing this, the rivet part 66 is formed at a tip end part (lower end part of FIG. 3) of the connecting part 88 of the negative electrode terminal 60. In addition, when the caulking process is performed, by adding the compression force in the vertical direction Z, air existing between the first conductive member 70 and the second conductive member 80 is emitted from the penetration hole 72 of the first conductive member 70. By doing this, a closely bonded property with the first conductive member 70 and the second conductive member 80 is enhanced. In other words, for example, even when the water, or the like, invades into a position between the first conductive member 70 and the second conductive member 80, it becomes harder that the water, or the like, osmoses widely.

By performing the caulking process as described above, the base 43 of the gasket 40 and the flat-plate shape portion of the insulator 46 are compressed, the gasket 40, the sealing plate 30, the insulator 46, and the negative electrode current collector 10 are integrally fixed to the sealing plate 30, and the terminal attaching hole 32 is sealed. Incidentally, an attaching method for the positive electrode terminal 50 and the positive electrode current collector 8 may be similar to the above described attaching method for the negative electrode terminal 60 and the negative electrode current collector 10. The negative electrode current collector 10 is joined to the negative electrode current collector foil exposed part of the negative electrode current collector foil 4, so as to electrically connect the negative electrode of the electrode body 1 and the negative electrode terminal 60. Similarly, the positive electrode current collector 8 is joined to the positive electrode current collector foil exposed part of the positive electrode current collector foil 2, so as to electrically connect the positive electrode of the electrode body 1 and the positive electrode terminal 50. By doing this, the sealing plate 30, the positive electrode terminal 50, the negative electrode terminal 60, and the electrode assembly are integrated.

At the joining step, the electrode body 1 integrated with the sealing plate 30 is accommodated in an internal space of the case main body 22, and then the case main body 22 and the sealing plate 30 are sealed. The sealing operation can be performed, for example, by welding, such as laser welding. After that, a nonaqueous electrolytic solution is injected through a liquid injection port not shown in figures, and then the liquid injection port is covered, so that the battery 100 is hermetically sealed. By doing as described above, it is possible to produce the battery 100.

In one suitable aspect disclosed herein, the battery 100 includes the electrode body 1 including the positive electrode and the negative electrode, includes the battery case 20, includes the positive electrode current collector 8 electrically connected to the positive electrode, and includes the negative electrode current collector 10 electrically connected to the negative electrode. Furthermore, the battery case 20 (specifically, sealing plate 30) includes the terminal attaching hole 32, and the second conductive member 80 includes the flange part 81 at one end part and the connecting part 88 at the other end part. Then, the flange part 81 is connected to the first conductive member 70, and the first conductive member 70 is arranged at the outer side of the battery case 20. On the other hand, the connecting part 88 of the second conductive member 80 penetrates the terminal attaching hole 32, and is connected to the negative electrode current collector 10 at the inner side of the battery case 20.

Although the battery 100 can be used for various purposes, it is possible to suitably use the battery for a purpose in which water, or the like, could come into contact with the negative electrode terminal 60 and the positive electrode terminal 50 at the use time, typically for a vehicle, for example, as a power source for motor (power supply for drive) mounted on a passenger car, truck, or the like. The kind of the vehicle is not particularly restricted, but it is possible to use it, for example, on a plug-in hybrid electric vehicle (PHEV), a hybrid electric vehicle (HEV), a battery electric vehicle (BEV), or the like.

As shown in FIG. 7, the battery 100 can be suitably used as a battery pack 140 in which plural batteries 100 are mutually and electrically connected through a bus bar 120. In that case, the electrical connection between the plural batteries 100 can be implemented, for example, by building a flat-plate shaped bus bar 120 on the first conductive members 70 (specifically, upper surfaces 70u of the first conductive member 70). The bus bar 120 consists of, for example, an electrically conductive metal, such as aluminum, aluminum alloy, nickel, and stainless steel. The bus bar 120 and the first conductive member 70 can be electrically connected by, for example, welding, such as laser welding.

In the present disclosure, it is preferable that the bus bar 120 is arranged at a portion covered by the tape 90 and/or the resin member 96. Additionally, in a case where the bus bar 120 is arranged with the configuration described above, it is preferable that the whole of the resin member 96 (and/or the tape 90) is arranged in the penetration hole 72 (in other words, the resin member does not protrude to the outer side from the penetration hole 72). FIG. 8 is a longitudinal cross section view that is for schematically showing the main part in a case where the bus bar 120 is arranged on a negative electrode terminal 360 in accordance with Embodiment 3. The negative electrode terminal 360 may be similar to the above described negative electrode terminal 60, other than a configuration of including a resin member 396 instead of the tape 90. As shown in FIG. 8, the resin member 396 is arranged to fill the first area 73 and to cover a part of the flat area 75. On the other hand, at an outer side more than the penetration hole 72 (outer edge part more than the second area 74), a resin member 396 is not arranged. Then, the bus bar 120 is arranged to cover the resin member 396 so as to abut with the upper surface 70u of the first conductive member 70. By doing this, it is possible to keep the connection with the negative electrode terminal 360 and the bus bar 120 in a stable manner. However, the bus bar 120 may be arranged at an extension part of the first conductive member 70 (left end in FIG. 4). This case, when the tape 90 is pasted at an outer circumferential edge of the penetration hole 72 on the upper surface 70u of the first conductive member 70, is suitable because this configuration does not interfere with the bus bar welding.

Above, some embodiments in accordance with the present disclosure has been explained, but the embodiments are merely illustrative. The present disclosure can be executed in various other forms. The present disclosure can be executed based on the contents disclosed in the present specification, and the technical common sense in the present field. The technique recited in the appended claims includes variously deformed or changed versions of the embodiments that have been illustrated above. For example, one part of the above-described embodiment can be replaced with another deformed aspect, and furthermore another deformed aspect can be added to the above described embodiment. In addition, unless a technical feature is explained to be essential, this technical feature can be appropriately deleted.

For example, in Embodiment 1 described above, the tape 90 has been arranged to come into contact with the surface 64a of the welded joint 64. However, the present disclosure is not restricted to this. It is not always required to make the tape 90 come into contact with the surface 64a of the welded joint 64.

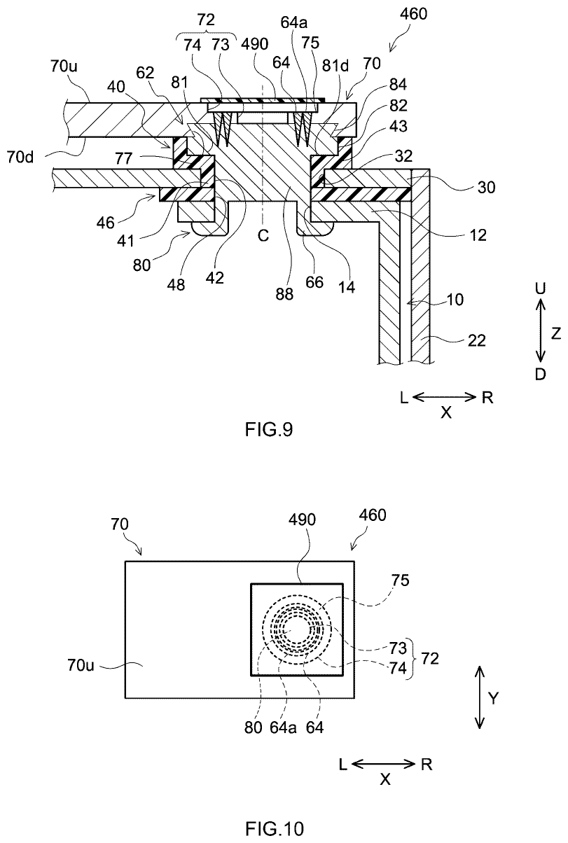

FIG. 9 is a longitudinal cross section view that is for schematically showing a main part of a negative electrode terminal 460 in accordance with Embodiment 4. In addition, FIG. 10 is a plane view that is for schematically showing the main part of the negative electrode terminal 460 in accordance with Embodiment 4. The negative electrode terminal 460 may be similar to the negative electrode terminal 60, other than a configuration of including a tape 490 instead of the tape 90. As shown in FIG. 9 and FIG. 10, the tape 490 herein is pasted on the outer edge part (in other words, outer circumferential edge of the penetration hole 72) of the second area 74 among the upper surface 70u of the first conductive member 70, while covering the surface 64a of the welded joint 64. In other words, arrangement is performed to make at least a part of the tape 490 abut on the upper surface 70u of the first conductive member 70. In accordance with the configuration described above, it is possible to implement the configuration in which the tape 490 and the surface 64a of the welded joint 64 are spaced away from each other. By doing this, at a large current rapidly charging and discharging time, when the temperature of the welded joint 64 becomes high, it is possible to reduce a heat effect on the tape 490 from the welded joint 64. Additionally, according to the configuration described above, in a case where the bus bar 120 is arranged at an extension part (left end in FIG. 4) of the first conductive member 70 of the negative electrode terminal 460, it is suitable because this configuration does not interfere with the bus bar welding.

For example, in Embodiment 1 described above, the first conductive member 70 includes the penetration hole 72. However, the present disclosure is not restricted to this. On the present disclosure, the penetration hole 72 is not essential, and may be omitted in another embodiment.

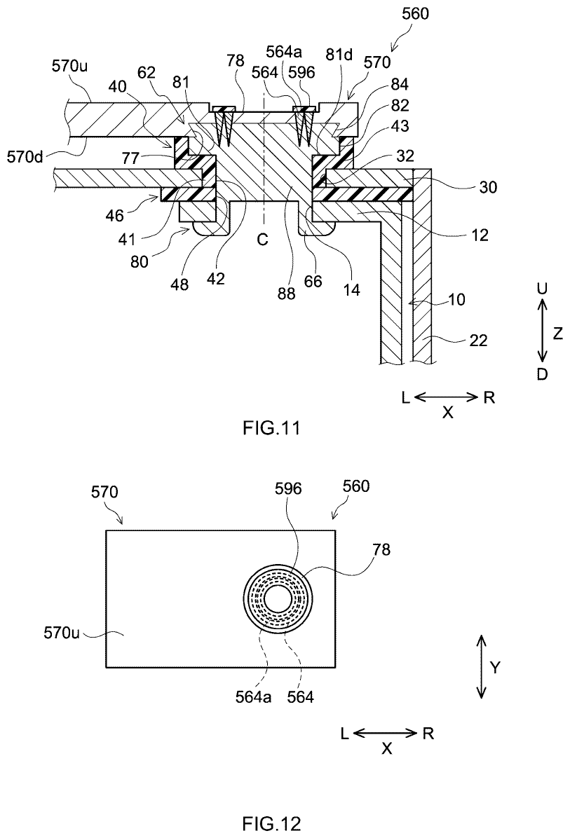

FIG. 11 is a longitudinal cross section view that is for schematically showing a main part of a negative electrode terminal 560 in accordance with Embodiment 5. In addition, FIG. 12 is a plane view that is for schematically showing the main part of the negative electrode terminal 560 in accordance with Embodiment 5. The negative electrode terminal 560 includes a first conductive member 570 and a welded joint 564, and includes a resin member 596 instead of the tape 90, and the other configurations may be similar to the negative electrode terminal 60. As shown in FIG. 11 and FIG. 12, the first conductive member 570 herein includes a lower surface 570d and an upper surface 570u, and includes a thin-walled part 78 (see FIG. 11 and FIG. 12) that is recessed from the upper surface 570u of the first conductive member 570 (formed to have a small thickness), as a substitute for the penetration hole. The thin-walled part 78 is formed to have a ring shape (for example, annular shape) in a plane view. The welded joint 564 herein is provided on the thin-walled part 78. By doing this, it is possible to reduce the required energy at the joining operation so as to enhance the welding property. The resin member 596 is arranged to cover the surface 564a of the welded joint 564. The resin member 596 herein is formed in a toroidal shape. By doing this, it is possible to reduce the amount of the resin member 596 so as to cover the surface 564a of the welded joint 564.

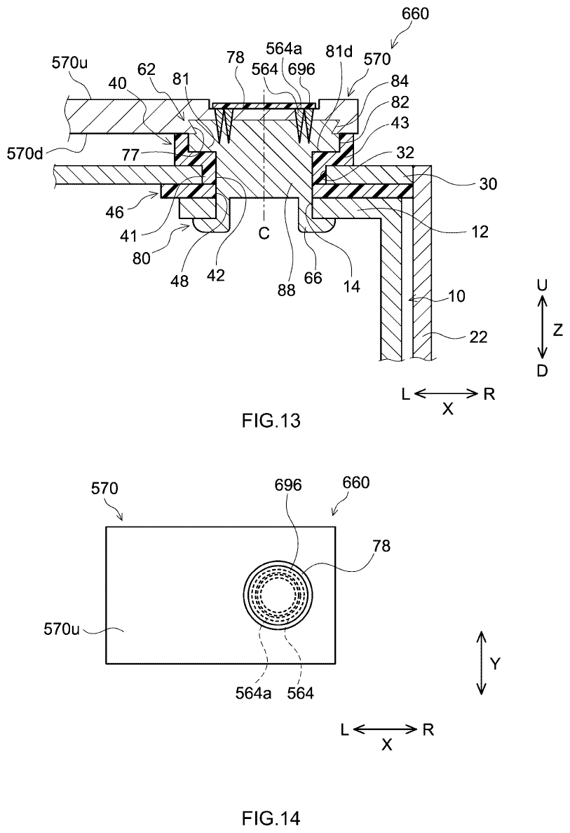

In addition, FIG. 13 is a longitudinal cross section view that is for schematically showing a main part of a negative electrode terminal 660 in accordance with Embodiment 6. In addition, FIG. 14 is a plane view that is for schematically showing the main part of the negative electrode terminal 660 in accordance with Embodiment 6. The negative electrode terminal 660 includes a resin member 696 instead of the resin member 596, and the configuration other than including it instead may be similar to the negative electrode terminal 560 in accordance with Embodiment 5. The resin member 696 herein is formed in an approximately circular shape, and is arranged to cover the surface 564a of the welded joint 564. In accordance with the configuration described above, the resin member 696 further surely covers the surface 564a of the welded joint 564. By doing this, it is possible to omit a confirmation with an image inspection, whether the resin member 696 covers the surface 564a of the welded joint 564 or not.

Additionally, as shown in FIG. 8, regarding Embodiment 3, the resin member 396 is arranged to fill the inside of the first area 73 and to cover a part of the flat area 75. In accordance with the configuration described above, the resin member 396 is configured to cover the welded joint 64 and further cover the boundary part 76 which is a abutting portion with a lower end part of the penetration hole 72 (first area 73) and the second conductive member 80. By doing this, it is possible to prevent the infiltration of the water, or the like, from the surface 64a of the welded joint 64 and to prevent the water, or the like, from coming into contact with the first conductive member 70 and the second conductive member 80 through the boundary part 76. Therefore, it is possible to further suitably suppress the corrosions of the first conductive member 70 and the second conductive member 80.

As described above, a configuration described in each of below items can be used as a particular aspect for the present disclosure.

Item 1: A terminal, including: a first conductive member; a second conductive member that is electrically connected to the first conductive member; and a welded joint that is for welding and joining the first conductive member and the second conductive member, wherein the first conductive member and the second conductive member are composed of mutually different metals, the welded joint is disposed to penetrate the first conductive member so as to reach the second conductive member, and a surface of the welded joint is covered with a tape or a resin member.

Item 2: The terminal described in Item 1, wherein the first conductive member has a plate shape, the second conductive member includes a flange part, and a fastening part that mechanically fixes the first conductive member and the flange part is provided.

Item 3: The terminal described in Item 2, wherein the first conductive member includes a recess that is configured to accommodate at least a part of the flange part.

Item 4: The terminal described in any one of Items 1 to 3, wherein the first conductive member includes a penetration hole.

Item 5: The terminal described in Item 4, wherein the penetration hole includes a first area and a second area, the first area is an area whose diameter is smaller than the second area, and the first area is arranged at a position closer to the second conductive member, than the second area.

Item 6: The terminal described in any one of Items 1 to 5, wherein the tape is pasted on the first conductive member.

Item 7: The terminal described in any one of Items 4 to 6, wherein the resin member is arranged inside the penetration hole.

Item 8: A battery, including, the terminal described in any one of Items 1 to 7, an electrode assembly provided with a positive electrode and a negative electrode, and a battery case configured to accommodate the electrode assembly, wherein the battery includes an electrically collecting body that is electrically connected to the positive electrode or the negative electrode, the battery case includes a terminal attaching hole, the second conductive member includes a flange part at one end part and includes a connecting part at the other end part, the flange part is connected to the first conductive member, the first conductive member is arranged at an outer side of the battery case, and the connecting part of the second conductive member is configured to penetrate the terminal attaching hole of the battery case so as to be connected to the electrically collecting body at an inner side of the battery case.

What is claimed is:

1. A terminal, comprising:
a first conductive member;
a second conductive member that is electrically connected to the first conductive member; and
a welded joint that is for welding and joining the first conductive member and the second conductive member, wherein
the first conductive member and the second conductive member are composed of mutually different metals,
the welded joint is disposed to penetrate the first conductive member so as to reach the second conductive member, and
a surface of the welded joint is covered with a tape or a resin member.

2. The terminal according to claim 1, wherein
the first conductive member has a plate shape,
the second conductive member comprises a flange part, and
a fastening part that mechanically fixes the first conductive member and the flange part is provided.

3. The terminal according to claim 2, wherein
the first conductive member comprises a recess that is configured to accommodate at least a part of the flange part.

4. The terminal according to claim 1, wherein
the first conductive member comprises a penetration hole.

5. The terminal according to claim 4, wherein
the penetration hole comprises a first area and a second area,
the first area is an area whose diameter is smaller than the second area, and
the first area is arranged at a position closer to the second conductive member, than the second area.

6. The terminal according to claim 1, wherein
the tape is pasted on the first conductive member.

7. The terminal according to claim 4, wherein
the resin member is arranged inside the penetration hole.

8. A battery, comprising:
the terminal according to claim 1;
an electrode body provided with a positive electrode and a negative electrode; and
a battery case configured to accommodate the electrode body, wherein
the battery comprises an electrode current collector that is electrically connected to the positive electrode or the negative electrode,
the battery case comprises a terminal attaching hole,
the second conductive member comprises a flange part at one end part and comprises a connecting part at the other end part,
the flange part is connected to the first conductive member,
the first conductive member is arranged at an outer side of the battery case, and
the connecting part of the second conductive member is configured to penetrate the terminal attaching hole of the battery case so as to be connected to the electrode current collector at an inner side of the battery case.
